(19) United States
(12) Patent Application Publication
(10) Pub. No.: US 2026/0117910 A1
(43) Pub. Date: Apr. 30, 2026

(54) COUPLERS AND ADAPTORS FOR VAPOR MITIGATION IMPLEMENTATIONS

(71) Applicant: Vapor Remediation Technology, Blairstown, NJ (US)

(72) Inventors: Thomas E. HATTON, Blairstown, NJ (US); Douglas A. Brookes, JR., Dover, NJ (US)

(21) Appl. No.: 19/368,906

(22) Filed: Oct. 24, 2025

Related U.S. Application Data
(60) Provisional application No. 63/712,108, filed on Oct. 25, 2024.

(51) Int. Cl. F16L 55/07; F16L 43/00

(52) U.S. Cl. CPC F16L 55/07; F16L 43/00

(57) ABSTRACT

Couplers and adaptors (e.g., connectors) for vapor mitigation implementation and systems for mitigating vapor are described herein. A vapor mitigation system may include a first vapor mitigation conduit proximate a substrate, a second vapor mitigation conduit, and a connector, where the connector includes a body comprising a first portion and a second portion, a first aperture proximate the first portion for operatively coupling with the first vapor mitigation conduit, and a second aperture proximate the second portion for operatively coupling with the second vapor mitigation conduit, where the second aperture is in fluid communication with the first aperture.

### CROSS-REFERENCE TO RELATED APPLICATIONS

The present application claims priority to U.S. Provisional Application No. 63/712,108, filed on Oct. 25, 2024, and titled “COUPLERS AND ADAPTORS FOR VAPOR MITIGATION IMPLEMENTATIONS,” the entirety of which is incorporated by reference herein.

### FIELD

Example embodiments of the present disclosure relate generally to connectors and, more particularly, to connectors as used with various vapor mitigation conduit of vapor mitigation systems.

### BACKGROUND

Vapor intrusion may refer to a process by which chemicals (e.g., volatile organic compounds (VOCs), methane, radon, and/or the like) in soil and/or groundwater mitigate to or seep into building spaces. As a result of vapor intrusion, the air within buildings may become contaminated, thereby exposing individuals within the buildings to chemical contamination, such as VOC and/or radon contamination. Complex installations of vapor mitigation implementations often require vapor mitigation conduit of various shapes which do not connect to each other without inhibiting airflow within the vapor mitigation conduit, thereby limiting the effectiveness of these vapor mitigation implementations. Through applied effort, ingenuity, and innovation, many of the problems associated with conventional connectors (e.g., couplers and adapters) used in vapor mitigation have been solved by developing solutions that are included in embodiments of the present disclosure, many examples of which are described in detail herein.

### BRIEF SUMMARY

Systems and devices are disclosed herein for couplers and adaptors as used in example vapor mitigation systems.

In one aspect of the disclosure, a connector for vapor mitigation conduit is presented. The connector may include a body having a first portion and a second portion, a first aperture proximate the first portion for operatively coupling with a first vapor mitigation conduit, and a second aperture proximate the second portion for operatively coupling with a second vapor mitigation conduit, wherein the second aperture may be in fluid communication with the first aperture.

In another aspect of the disclosure, a system for vapor mitigation is presented. The system may include a first vapor mitigation conduit proximate a substrate, a second vapor mitigation conduit, a connector, and a flow generator operatively coupled to the second vapor mitigation conduit to move the vapors from the first vapor mitigation conduit to the second vapor mitigation conduit via the connector. The connector may include a body including a first portion and a second portion, a first aperture proximate the first portion for operatively coupling with the first vapor mitigation conduit, and a second aperture proximate the second portion for operatively coupling with the second vapor mitigation conduit, wherein the second aperture may be in fluid communication with the first aperture, and a flow generator operatively coupled to the second vapor mitigation conduit to move the vapors from the first vapor mitigation conduit to the second vapor mitigation conduit via the connector.

In some embodiments, the first vapor mitigation conduit or the second vapor mitigation conduit may include a vapor mat.

Additionally, or alternatively, in some embodiments, the first vapor mitigation conduit or the second vapor mitigation conduit may include a tubular body.

Additionally, or alternatively, in some embodiments, the body may include a cavity for operatively coupling the first aperture to the second aperture, and wherein the connector further may include at least one drainage aperture in fluid communication with the cavity for draining condensate to outside the connector.

Additionally, or alternatively, in some embodiments the connector may further include one or more supports extending through a top wall and a bottom wall of the cavity.

Additionally, or alternatively, in some embodiments, the first portion and the second portion are disposed on opposing sides of a longitudinal axis of the body.

Additionally, or alternatively, in some embodiments, the connector may further include one or more sleeves parallel to the longitudinal axis on opposing sides of the connector for receiving reinforcement rods or electrical conduit.

Additionally, or alternatively, in some embodiments, the connector may further include a receptacle proximate the first portion or the second portion, the receptacle structured to receive an adjacent connector therein.

Additionally, or alternatively, in some embodiments, the first portion and the second portion are arranged such that the first vapor mitigation conduit and the second mitigation conduit are oriented substantially orthogonally to one another.

Additionally, or alternatively, in some embodiments, the body may include a cavity for operatively coupling the first aperture to the second aperture, and wherein the cavity is at least partially defined by an arc having a radius extending from the first aperture to the second aperture.

Additionally, or alternatively, in some embodiments, the first portion is rotatably coupled to the second portion, such that the first vapor mitigation conduit and the second mitigation conduit are selectively positionable relative to one another.

Additionally, or alternatively, in some embodiments, the first portion or the second portion may include a flexible member, wherein the other of the first portion and the second portion may include a track structured to slidably receive the flexible member as the first portion rotates relative to the second portion.

Additionally, or alternatively, in some embodiments, the first portion and the second portion are rotatable between 10 and 110 degrees relative to each other.

Additionally, or alternatively, in some embodiments, the body may further include at least one securing aperture for receiving a substrate anchor operative to secure at least a portion of the body substantially stationary relative to a substrate.

Additionally, or alternatively, in some embodiments, the substrate anchor is further operative to secure the first vapor mitigation conduit or the second vapor mitigation conduit substantially stationary relative to the body.

Additionally, or alternatively, in some embodiments, at least one of the first aperture and the second aperture are defined by at least one knockout removable for selective sizing.

Additionally, or alternatively, in some embodiments, removing the at least one knockout allows for a third vapor mitigation conduit to be received therein, the third vapor mitigation conduit in a stacked configuration with the first vapor mitigation conduit or the second vapor mitigation conduit.

Additionally, or alternatively, in some embodiments, the connector may further include a marker connector for receiving a marker therein.

Additionally, or alternatively, in some embodiments, the marker may include a flag, and wherein the maker connector may include a coupling for securing the marker.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1A illustrates a plan view of an exemplary connector (e.g., a fixed-angle rectangular vapor mitigation conduit connector) in accordance with one or more embodiments of the present disclosure;

FIG. 1B illustrates a perspective view of the connector of FIG. 1A, in accordance with one or more embodiments of the present disclosure;

FIG. 1C illustrates a side view of the connector of FIG. 1A, in accordance with one or more embodiments of the present disclosure;

FIG. 1D illustrates a front view of the connector of FIG. 1A, in accordance with one or more embodiments of the present disclosure;

FIG. 2A illustrates a side view of an exemplary connector (e.g., a single layer straight rectangular vapor mitigation conduit connector) in accordance with one or more embodiments of the present disclosure;

FIG. 2B illustrates a front view of the connector of FIG. 2A, in accordance with one or more embodiments of the present disclosure;

FIG. 2C illustrates a side view of an exemplary connector (e.g., a single layer straight rectangular vapor mitigation conduit connector) in accordance with one or more embodiments of the present disclosure;

FIG. 2D illustrates a front view of the connector of FIG. 2C, in accordance with one or more embodiments of the present disclosure;

FIG. 3A illustrates a side view of an exemplary connector (e.g., a double layer straight rectangular vapor mitigation conduit connector) in accordance with one or more embodiments of the present disclosure;

FIG. 3B illustrates a front view of the connector of FIG. 3A, in accordance with one or more embodiments of the present disclosure;

FIG. 3C illustrates a side view of an exemplary connector (e.g., a double layer straight rectangular vapor mitigation conduit connector) in accordance with one or more embodiments of the present disclosure;

FIG. 3D illustrates a front view of the connector of FIG. 3C, in accordance with one or more embodiments of the present disclosure;

FIG. 4A illustrates a plan view of an exemplary connector (e.g., a rectangular vapor mitigation conduit to tubular conduit trunk line connector), in accordance with one or more embodiments of the present disclosure;

FIG. 4B illustrates a perspective view of the connector of FIG. 4A, in accordance with one or more embodiments of the present disclosure;

FIG. 4C illustrates a side view of the connector of FIG. 4A, in accordance with one or more embodiments of the present disclosure;

FIG. 4D illustrates a front view of the connector of FIG. 4A, in accordance with one or more embodiments of the present disclosure;

FIG. 5A illustrates a perspective view of an exemplary connector (e.g., an adjustable angle rectangular vapor mitigation conduit connector), in accordance with one or more embodiments of the present disclosure;

FIG. 5B illustrates a plan view of the connector of FIG. 5A, in accordance with one or more embodiments of the present disclosure;

FIG. 5C illustrates a side view of the connector of FIG. 5A, in accordance with one or more embodiments of the present disclosure;

FIG. 5D illustrates a front view of the connector of FIG. 5A, in accordance with one or more embodiments of the present disclosure;

FIG. 5E illustrates a plan view of a first subconnector of the connector of FIG. 5A, in accordance with one or more embodiments of the present disclosure;

FIG. 5F illustrates a side view of the first subconnector of FIG. 5E, in accordance with one or more embodiments of the present disclosure;

FIG. 5G illustrates a front view of the first subconnector of FIG. 5E, in accordance with one or more embodiments of the present disclosure;

FIG. 5H illustrates a plan view of a second subconnector of the connector of FIG. 5A, in accordance with one or more embodiments of the present disclosure;

FIG. 5I illustrates a side view of the second subconnector of FIG. 5H, in accordance with one or more embodiments of the present disclosure;

FIG. 5J illustrates a plan view of an exemplary connector (e.g., an adjustable angle rectangular vapor mitigation conduit connector), in accordance with one or more embodiments of the present disclosure;

FIG. 5K illustrates a perspective view of the connector of FIG. 5J, in accordance with one or more embodiments of the present disclosure;

FIG. 6A illustrates a front perspective view of a vapor mitigation conduit (e.g., a vent mat), in accordance with one or more embodiments of the present disclosure; and

FIG. 6B illustrates a plan view of the vapor mitigation conduit of FIG. 6A, in accordance with one or more embodiments of the present disclosure.

### DETAILED DESCRIPTION

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

Vapor intrusion is a process by which chemicals (e.g., volatile organic compounds (VOCs), methane, radon, etc.) in soil and/or groundwater migrate to or seep into building spaces. These vapors can be released from contaminated soil and/or groundwater underneath buildings, and may enter basements, crawl spaces, rooms and/or other areas of a building or structure. As a result of vapor intrusion, the air within buildings may become contaminated, thereby exposing individuals within the buildings to chemical contamination, such as VOC and/or radon contamination.

Generally, VOCs are man-made chemical compounds that have a high vapor pressure and low water solubility. VOCs can be used and produced in the manufacture of fuels, paints, pharmaceuticals, and refrigerants, and are typically included in industrial solvents, paint thinners, tetrachloroethylene (dry cleaning fluid), fuel oxygenates (MTBE), and by-products produced by chlorination in water treatment. VOC contaminants can travel with or on top of groundwater and may easily become gaseous and migrate through soil. As a result of negative pressures that are induced by various building designs and features, VOCs can be drawn from the soil and/or groundwater, and into occupied spaces of buildings where human exposure can occur.

Radon is a Class A carcinogen that, according to scientific studies, may cause harmful effects on human lung tissue. Like VOCs, radon may be drawn into buildings from the underlying soil and/or groundwater by the negative pressures that are associated with the structure and features of buildings. Negative pressure can be caused by factors, such as temperature differentials where warm air exits an upper portion of a building (induces a stack effect), and wind and exhaust appliances that create additional vacuum. These forces can draw in VOC and/or radon gases through cracks, conduit openings and other pathways in slabs, sub-slabs or other flooring features of buildings.

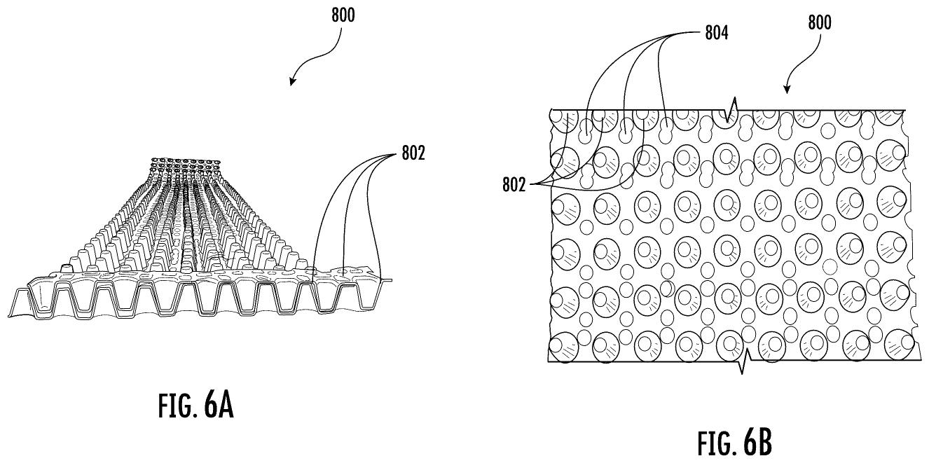

To remedy vapor intrusion, a flow generator (e.g., a vacuum, pump, fan, or other air movement device) may be operatively coupled to vapor mitigation conduit to move the vapors from the substrate to a safe release area. Vapor mitigation conduit may include, for example, one or more sections of vapor mat (e.g., as shown in FIGS. 6A-6B, sometimes referred to herein as “rectangular vapor mitigation conduit”). Complex installations, such as those contemplated by the present disclosure, may require collection and movement of the vapors from the rectangular vapor mitigation conduit to one or more additional rectangular vapor mitigation conduits and/or to other vapor mitigation conduit such as “tubular conduit” (e.g., pipe, tubing, or the like).

The effectiveness of a passive soil gas ventilation system (e.g., a vapor mitigation implementation) relies on airflow from a soil gas reservoir that exists as void space between the individual pieces of stone within a gravel bed that exists between, for example, a floor slab and the underlying soil. Similar to a round soil gas vent pipe, there is often a need to change the direction of rectangular vapor mitigation conduit material and its corresponding air/vapor flow. Because of the interior plastic cone support structure of the rectangular vapor mitigation conduit material, the open space within a vent through which air may be conveyed is reduced to approximately 5.6 square inches or about the equivalent of that of a 2.6 inch tubular conduit. Moreover, if the rectangular vapor mitigation conduit is miter cut and joined, the interior structural support cones are misaligned, further reducing the air flow rate, by causing air turbulence which induces drag.

The present disclosure provides for connectors (e.g., connectors 100, 200, 300, 400, 500, 600, 700, or the like) for connecting the rectangular vapor mitigation conduit (i) to one or more additional rectangular vapor mitigation conduit, and/or (ii) to one or more tubular conduit, in various configurations, adjustability, features, or the like, as will be described henceforth, without the airflow and installation inefficiencies of traditional connectors. Indeed, the introduction of the disclosed connectors not only reduces the occurrence of time-consuming, ad-hoc field alterations by construction personnel, but also improves the efficiency and effectiveness of soil gas ventilation systems.

The connectors (e.g., connectors 100, 200, 300, 400, 500, 600, 700, or the like, as described herein) may be fabricated from any suitable material or combination of materials. In some embodiments, any non-corrosive and/or non-oxidizing materials may be used to prevent degradation of connectors that can occur in harsh sub slab environments.

Connectors may be fabricated of plastic, and manufactured through injection molding, blow molding, rotational molding, thermoforming, vacuum forming, compression molding, extrusion, machining of plastic stock, 3D printing, or the like. The plastic used may include thermoplastics such as ABS, polycarbonate, polypropylene, polyethylene, polyamide (nylon), polystyrene, Delrin, acrylic, thermoplastic polyurethane, or the like thermoplastic polymers or thermosetting materials such as epoxy, phenolic, melamine resins, or the like. Fabricated components of plastic may also include filled or reinforced plastics like glass-filled nylon, carbon fiber-reinforced ABS, mineral-filled polypropylene, or the like.

In some embodiments, reclaimed (e.g., recycled) and/or further recyclable plastics may be used. For example, the use of recycled materials (e.g., recycled HDPE, LDPE, PET, or the like) may contribute to LEED points or other incentive programs which may qualify the owner for tax and other monetary benefits.

Additionally, or alternatively, a connector may be a sheet metal part through processes such as stamping, bending, laser cutting, waterjet cutting, punching, or deep drawing, which may include the use materials including aluminum alloys (e.g., 5052, 6061), stainless steels (e.g., 304, 316), carbon steels (cold-rolled or hot-rolled), galvanized steels, copper, brass, titanium, or the like. Additionally, or alternatively, some or all of the fabricated components may be produced from metal stock using subtractive manufacturing techniques such as CNC milling, turning, drilling, grinding, electrical discharge machining, or the like, using ferrous or non-ferrous metals, high-strength low-alloy steels, tool steels, spring steels, alloys, or the like. Additionally, or alternatively the components described herein may be formed through casting or other manufacturing processes Additionally, or alternatively, some or all of the fabricated components may be composed of composite materials. Composite compositions may include fiber-reinforced polymers with carbon, graphene, glass, aramid, natural fibers, or the like embedded therein. Additionally, or alternatively, some or all of the fabricated components may be produced using additive manufacturing methods such as fused deposition modeling, selective laser sintering, stereolithography, direct metal laser sintering, or the like processes, from polymeric, metallic, and/or composite feedstocks. Additionally, or alternatively, some or all of the fabricated components may be cast, forged, extruded, die cut, laminated, bonded from layers, or the like.

It should be appreciated that connectors may be composed of differing materials depending on functional requirements. For example, in some embodiments, certain connectors may be composed of metal while other certain fabricated components are composed of plastic or composite. In some embodiments, multiple certain connectors may be formed from a common material. In other embodiments, material selection may vary between the connectors to meet any design or performance requirements.

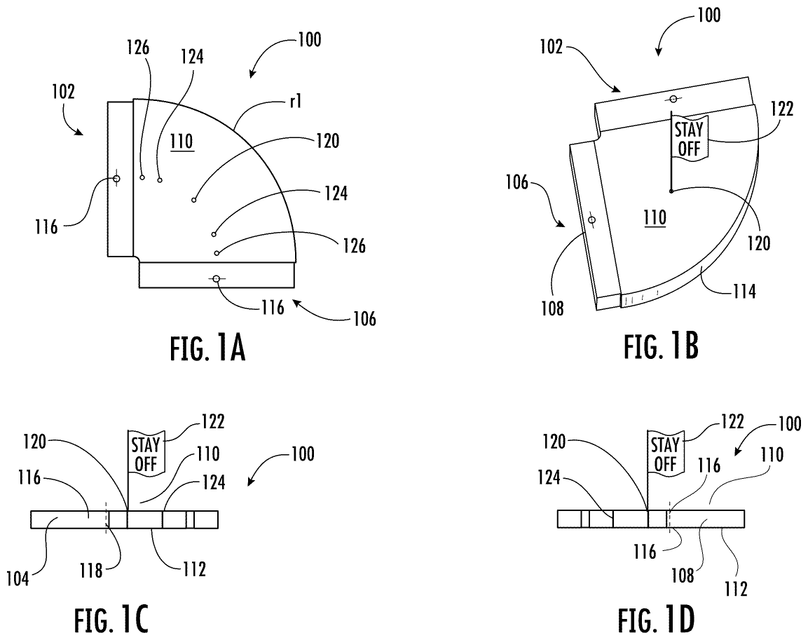

With reference to FIGS. 1A-1D, an exemplary connector 100 (e.g., a fixed-angle rectangular vapor mitigation conduit connector) is illustrated in accordance with one or more embodiments of the present disclosure.

The connector 100 may be defined by a body having a first portion 102 for receiving a first vapor mitigation conduit (e.g., a first rectangular vapor mitigation conduit) and a second portion 106 for receiving a second vapor mitigation conduit (e.g., a second rectangular vapor mitigation conduit). A top wall 110 may extend from an upper surface of the first portion 102 to an upper surface of the second portion 106, while a bottom wall 112 may be in a spaced relation from the top wall 110 and may extend from a lower surface of the first portion 102 to a lower surface of the second portion 106.

In some embodiments, the body may be structured as a unibody structure. In other embodiments, the body may be structured as two or more mating portions configured to interlock with one another. The mating portions may join along a split line extending substantially, horizontally, vertically, or in any other plane suitable for assembly or disassembly.

To receive the first vapor mitigation conduit, the first portion 102 may include a first aperture 104 proximate the first portion 102. To receive the second vapor mitigation conduit, the second portion 106 may include a second aperture 108 proximate the second portion 106.

In some embodiments, the first aperture 104 and/or the second aperture 108 may be defined by a rectangular cross-section having opposing long edges and opposing short edges, where the short edges extend generally vertical when the connector is oriented horizontally.

Additionally, or alternatively, the first aperture 104 and/or the second aperture 108 may be defined by a non-rectangular cross-section, and may be circular, oval, polygonal, irregular in shape, or the like. In some embodiments, the aperture may include curved, angled, contoured wall portions, keying features, notches, or tapered surfaces that guide insertion or improve sealing engagement.

As illustrated, the first portion 102 and the second portion 106 of the connector 100 may be arranged such that the first vapor mitigation conduit and the second mitigation conduit are oriented substantially orthogonally to one another. Stated differently, a theoretical longitudinal axis extending from the first aperture 104 may be positioned approximately 90 degrees from a theoretical longitudinal axis extending from the second aperture 108. While the illustrated embodiment depicts the first and second portions 102, 106 arranged at an angle of approximately 90°, other angular relationships are contemplated, including angles of about 30°, 45°, 60°, 75°, 105°, 120°, 135°, or 150°, as well as any intermediate values.

Extending from an outer short edge of the first aperture 104 to an outer short edge of the second aperture 108 may be an outer wall 114. In some embodiments, the outer wall 114 may extend along a defined radius r1 to result in a ninety-degree arc (e.g., a quarter circle).

To facilitate the fluid communication (e.g., the allowing of air flow) between the first aperture 104 and the second aperture 108, the body of the connector 100 may be a hollow member defining a cavity (e.g., an air channel) therein for operatively coupling the first aperture 104 to the second aperture 108, where in some embodiments the cavity may be at least partially defined by the top wall 110 and the bottom wall 112.

In some embodiments, the cavity may also be defined by the outer wall 114 (or another interior wall substantially tracing the path of the outer wall 114). This curved cavity configuration may facilitate airflow with reduced flow restriction and inducing only minimal turbulence and drag through the connector 100. Additionally, or alternatively, the cavity may include one or more contoured surfaces (e.g., surface transitions) such as chamfers, fillets, radii, or the like, for further reducing flow restriction.

In some embodiments, the first and/or second aperture 104, 108 may include a socket (e.g., coupling, adapter, or the like) for receiving the corresponding first and/or second vapor mitigation conduit. The socket may have a generally rectangular cross-sectional shape or other suitable profile for engagement. In some embodiments, the socket may include one or more raised projections within the aperture positioned to engage (e.g., squeeze, lock, prevent further insertion, or the like) the first and/or second vapor mitigation conduit.

With reference to FIGS. 6A-6B, an exemplary rectangular vapor mitigation conduit 800 (e.g., a vent mat) is illustrated. The vapor mitigation conduit 800 may be a venting structure for facilitating the movement and dispersion of subsurface gases beneath slabs or other vapor barriers. The vapor mitigation conduit 800 may take the form of a structured flat mat having a substantially rectangular cross section. Some embodiments have rectangular cross-sections measuring approximately 1 inch in height and twelve inches in width, though heights of 0.25, 0.75, 1.25, 1.5, 2, 3 inches, or the like are contemplated, as well as widths of 6, 8, 10, 12, 14, 16, 18, 20, 24, 36, 48 inches or the like. The vapor mitigation conduit 800 may be supplied in a roll or sheet form cuttable to lengths required for a particular installation.

The vapor mitigation conduit 800 may be constructed from a durable resin-based plastic having a repeating pattern of upwardly extending cones 802 formed integrally with the bottom wall. These cones 802 may create a network of interconnected voids that maintain air channels under imposed loads. The bottom wall of the vapor mitigation conduit 800 may include a distributed arrangement of apertures 804, allowing vapor to enter the conduit from below and/or moisture to pass through. Once inside, the vapor may move laterally through the internal void space.

By using a connector (e.g., connector 100, 200, 300, 400, 500, 600, 700, or the like) vapor may be collected from one or more segments of the vapor mitigation conduit 800 and routed to other vapor mitigation conduit (e.g., section(s) of vapor mitigation conduit 800 and/or tubular conduit such as pipe, tubing, or the like).

Referring back to FIGS. 1A-1D, the connector 100 may include at least one securing aperture 116. A securing aperture 116 may be any opening, hole, boss, raised feature, molded feature, or the like, that allows for passing of a substrate anchor (e.g., a stake, spike, or the like) therethrough. For example, a substrate anchor may be driven through the connector, through the vapor mitigation conduit (and/or, in other embodiments the tubular conduit), and into the underlying substrate (e.g., soil, ground, fill material, or the like). By securing the connector 100 via one or more substrate anchors, unwanted motion (e.g., twisting, turning, shifting, or the like) may be prevented.

In some embodiments, use of the substrate anchor may secure the first vapor mitigation conduit or the second vapor mitigation conduit substantially stationary relative to the connector by the substrate anchor being inserted through and extending through the first vapor mitigation conduit or the second vapor mitigation conduit.

In some embodiments, the connector 100 may include one or more drainage apertures (e.g., condensate relief ports) 118, 126. The one or more drainage apertures 118, 126 may be in fluid communication with the cavity of the connector and mitigate the accumulation of condensate water (e.g., caused by air turbulence, temperature differentials, pressure differentials, rainfall, or the like) inside the cavity of the connector that could, if not evacuated, reduce airflow of the connector.

In some embodiments, the one or more drainage apertures 118, 126 may extend through the top wall 110, bottom wall 112, or both, to provide for the draining of condensation to the underlying substrate. In some embodiments, the one or more drainage apertures 118, 126 may include two drainage apertures 118, 126 in vertical alignment with each other, such that a drainage aperture 118 of the top wall 110 may be aligned with a drainage aperture 118 of the bottom wall 112, thereby allowing for condensate or other liquids to pass through the top of the connector to the underlying substrate.

Positions of the one or more drainage apertures 118, 126 may vary by installation or connector geometry. As one non-limiting example, the one or more drainage apertures 118, 126 of the connector 100 may be positioned in the curved (e.g., arc) section of the body of the connector 100.

The drainage apertures 118, 126 may take one of several forms. In some embodiments, the drainage apertures 118, 126 may be simple holes (e.g., round holes, square holes, or the like) provided in the top wall and/or bottom wall. In other embodiments, a tubular member may extend between the top wall and the bottom wall to define a drainage passage. Additionally, or alternatively, one or more fittings may be installed within the drainage apertures 118, 126.

Since connectors are sometimes covered with crushed stone or other fill materials, in some embodiments the connector 100 may include a marker 122 that allows for the targeted uncovering of the connector or other component during inspection as part of the construction process. As used herein, a “marker” may refer to any element that extends upwardly and/or outwardly from the connector (e.g., connector 100, 200, 300, 400, 500, 600, 700, or the like) to provide a visible or otherwise detectable indication of the location of the connector. In some embodiments, as shown graphically, the marker 122 may take the form of a flag extending from a marker connector 120. In other embodiments, the marker 122 may be a light, reflective member, antenna, or any other structure or device suitable for identifying or signaling the position of the connector.

In some embodiments, the connector 100 may include a marker connector 120, which may be any feature for receiving, attaching, or otherwise engaging with a marker 122. In some embodiments, the marker connector 120 may be a hole or opening sized to receive a marker 122, such as an elongate portion of a flag or the like. In other embodiments, the marker connector 120 may be a threaded female or male coupling for receiving a corresponding threaded component of the marker 122. Additionally, or alternatively, the marker connector 120 may be any other mechanical, magnetic, friction-fit, or the like feature suitable for attaching or supporting a marker 122 in relation to the connector.

Similar to that which was previously described with respect to the one or more drainage apertures 118, 126, in some embodiments the marker connector 120 may include two apertures (or other marker connectors) in vertical alignment with each other, such that a marker connector 120 of the top wall 110 may be aligned with a marker connector 120 of the bottom wall 112. In this way, in some embodiments, a pair of vertically aligned apertures may provide for multi-purpose function, for example to be used for draining condensate liquid and/or for the securing of a marker 122.

In some embodiments, the connector 100 may include one or more supports 124 for providing vertical support and strengthening to the connector 100. To do so, the one or more supports 124 may extend from the top wall 110 to the bottom wall 112 (e.g., through the cavity).

In some embodiments, the one or more supports 124 may be defined by cone-shaped pillars, with a wider face of the pillar proximate the bottom wall 112 and the narrower face of the pillar proximate the top wall 110. Additionally, or alternatively, the wider face of the cone-shaped pillar may be proximate the top wall 110 and the narrower face proximate the bottom wall 112.

Additionally, or alternatively, in some embodiments, the one or more supports 124 may be defined by elongate members having a constant cross section, for example circular, oblong, square, rectangular, polygonal, or the like suitable cross-sectional profiles.

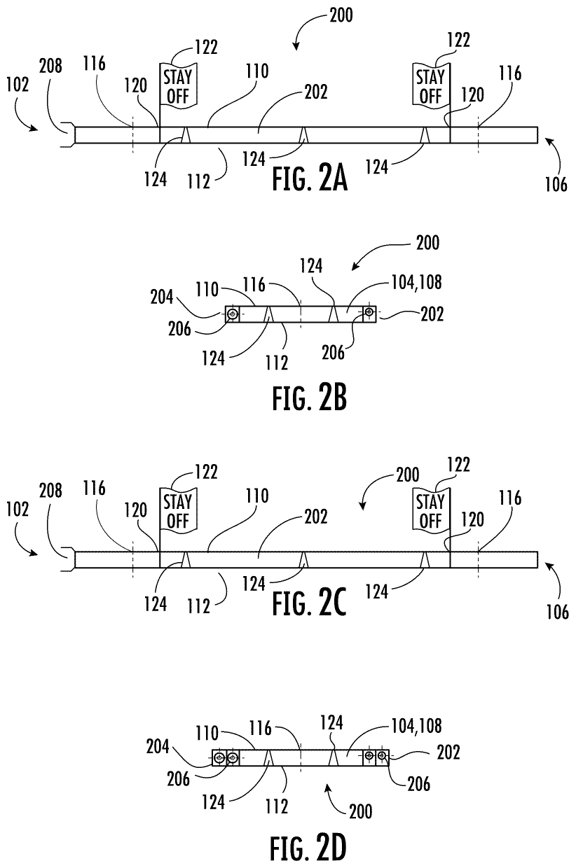

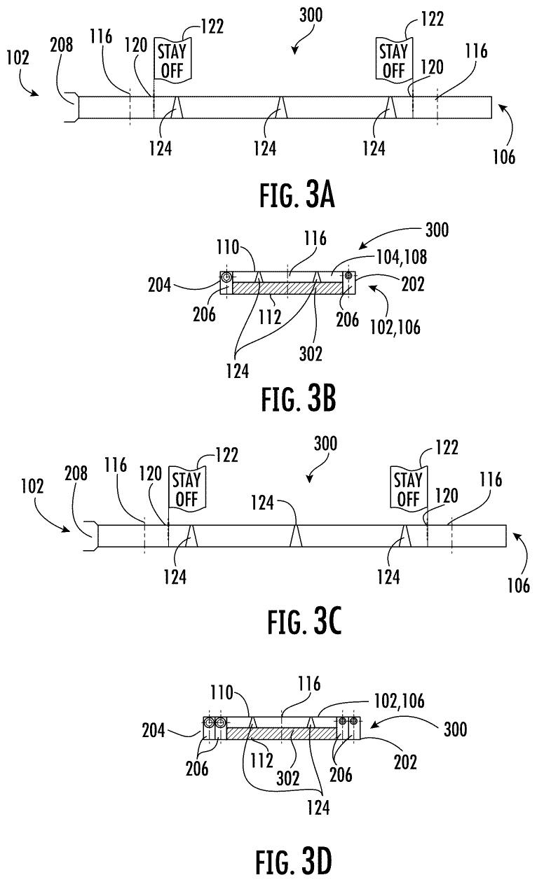

FIGS. 2A-2D illustrate an exemplary connector 200 (e.g., a single layer straight rectangular vapor mitigation conduit connector) in accordance with one or more embodiments of the present disclosure. FIGS. 3A-3D illustrate an exemplary connector 300 (e.g., a double layer straight rectangular vapor mitigation conduit connector) in accordance with one or more embodiments of the present disclosure.

Buildings are sometimes constructed with interior grade beams that support masonry walls and load bearing structures. Grade beam configurations and matrices can isolate areas of the subgrade into separate foundation compartments. The current state of the art is to transition grade beams and thickened slabs with sleeved or insulated round pipe. These pipe diameters and combined with code required insulation or sleeves can remove up to six inches or more of support from a grade beam or structural thickened slab, and may result in lost airflow efficiency when the rectangular vapor mitigation conduit mat is transitioned to a tubular conduit to penetrate a grade beam. Moreover, constructing flat-to-round transitioning pieces and the associated insulating sleeves is time-consuming, costly, and slows construction.

Furthermore, there may be associated electrical conduits, sensors, rebar, and/or the like that can run adjacent to the soil gas conveyance pipe and, as a result, remove the structural strength height area from the grade beam or thickened slab.

The connectors 200 and 300 provide a solution by transitioning vapor mitigation conduits through a concrete grade beam, haunch, thickened slab condition, or the like.

With reference generally to FIGS. 2A-3D, similar to that of connector 100, the connector 200, 300 may be defined by a body having a first portion 102 for receiving a first vapor mitigation conduit (e.g., a first rectangular vapor mitigation conduit) and a second portion 106 for receiving a second vapor mitigation conduit (e.g., a second rectangular vapor mitigation conduit). It should be appreciated that in some embodiments, a single vapor mitigation conduit may be received by the first aperture 104, extend along the longitudinal length of the connector 200, 300, and exit through the second aperture 108, such that the connector 200, 300 serves primarily as a structural guard or cover.

A top wall 110 of the connector 200, 300 may extend from an upper surface of the first portion 102 to an upper surface of the second portion 106, while a bottom wall 112 may be in a spaced relation from the top wall 110 and may extend from a lower surface of the first portion 102 to a lower surface of the second portion 106. The body of the connector 200 may define a first side 202 and a second side 204.

In some embodiments, the body may be structured as a unibody structure. In other embodiments, the body may be structured as two or more mating portions configured to interlock with one another. The mating portions may join along a split line extending substantially, horizontally, vertically, or in any other plane suitable for assembly or disassembly.

To receive the first vapor mitigation conduit, the first portion 102 may include a first aperture 104 proximate the first portion 102. To receive the second vapor mitigation conduit, the second portion 106 may include a second aperture 108 proximate the second portion 106.

In some embodiments, the first aperture 104 and/or the second aperture 108 may be defined by a rectangular cross-section having opposing long edges and opposing short edges, where the short edges extend generally vertical when the connector is oriented horizontally. Additionally, or alternatively, the first aperture 104 and/or the second aperture 108 may be defined by a non-rectangular cross-section, and may be circular, oval, polygonal, irregular in shape, or the like. In some embodiments, the aperture may include curved, angled, contoured wall portions, keying features, notches, or tapered surfaces that guide insertion or improve sealing engagement.

As illustrated, the first portion 102 and the second portion 106 of the connector 200, 300 may be arranged such that the first vapor mitigation conduit and the second mitigation conduit are in line with one another (e.g., aligned and disposed on opposing sides of a longitudinal axis of the body).

In some embodiments, a first internal wall may be in an inwardly spaced relation from the first side 202 and extend substantially parallel to the first side 202. Additionally, or alternatively, a second internal wall may be in an inwardly spaced relation from the second side 204 and extend substantially parallel to the second side 204. As a result, the body of the connector 200, 300 may define three or more cavities, for example a central cavity (e.g., a structural rectangular shaped chamber that protects a rectangular vapor mitigation conduit as it transitions solid barriers such as grade beams and thickened slabs) operatively coupled to (e.g., in fluid communication with) the first and second apertures 104, 108, and one or more outer cavities (referred to herein as sleeves 206) disposed on opposite sides of the central cavity and generally not in fluid communication with the first or second apertures 104, 108.

Indeed, the one or more sleeves 206 may receive reinforcement rod(s) (e.g., rebar), conduit used for sensor wire or other electronics, tubing, or the like, to provide structural reinforcement, connectivity, and/or the like without inhibiting air flow within the central cavity.

With reference to FIGS. 2A and 2B, in some embodiments, the connector 200 may define a single sleeve 206 along the first side 202 and a single sleeve 206 along the second side 204. With reference to FIGS. 2C and 2D, in some embodiments, the connector 200 may define two sleeves 206 along the first side 202 and two sleeves 206 along the second side 204. Additional configurations are contemplated, including connectors 200 having 3, 4, 5, 6, 7, 8 or more sleeves 206, a greater number of sleeves 206 along one side than the other side, or any combination of the foregoing.

Referring to FIGS. 3A-3D, in some embodiments, the first aperture 104 may be sized sufficient to receive not only the first vapor conduit, but also an additional vapor conduit (e.g., a “third” vapor mitigation conduit, such as a rectangular vapor mitigation conduit) in a stacked configuration with the first vapor conduit. Additionally, or alternatively, the second aperture 108 may be sized sufficient to receive not only the second vapor conduit, but also an additional vapor conduit (e.g., a “third” or “fourth” vapor mitigation conduit, such as a rectangular vapor mitigation conduit) in a stacked configuration with the first vapor conduit. In doing so, a connector 300 can support higher air flow in a compact size configuration that reduces the footprint required to do so.

To allow for the selective use of the connector 300 (e.g., an on-site determination and adjustment as to how many vapor mitigation conduits will be operatively coupled to the connector 300), the first aperture 104 and/or the second aperture 108 may include a knockout 302 that covers a portion of the first aperture 104 and/or the second aperture 108 sized to accommodate the third and/or fourth vapor mitigation conduit, such as to selectively size the aperture(s). Some embodiments of the knockout 302 may include partial cuts and/or score lines to define a weakened perimeter, one or more tabs/bridge connections to hold the knockout in place until broken, or the like, such that the knockout 302 may be manually removed or removed via cutting tools.

Referring generally to FIGS. 2A-3D, in some embodiments, the first and/or second aperture 104, 108 may include a socket (e.g., coupling, adapter, or the like) for receiving the corresponding first and/or second vapor mitigation conduit. The socket may have a generally rectangular cross-sectional shape or other suitable profile for engagement. In some embodiments, the socket may include one or more raised projections within the aperture positioned to engage (e.g., squeeze, lock, prevent further insertion, or the like) the first and/or second vapor mitigation conduit.

In some embodiments, the longitudinal length of a connector 200, 300 may be 4 feet. In other embodiments, the longitudinal length of the connector 200 may be 1 ft, 2 ft, 3 ft, 5 ft, 6 ft, 8 ft, 10 ft, 12 ft, 14 ft, 20 ft, or the like, or any other length.

In some embodiments, two or more connectors 200, 300 (or any combination of connectors 100, 200, 300, 400, 500, 600, 700, or the like) may be joined end-to-end (e.g., such that apertures of adjacent connectors are in fluid communication with each other) such as to result in a longer length of connector, route away from features of the installation, reach target areas, or the like. As such connector 200, 300 may include a receptacle 208 at the first aperture 104 and/or the second aperture 108. The receptacle 208 may be a flanged member having outwardly expanding cross-section, tabs, wings, or the like, suitable for receiving the outer portion of the adjacent connector therein.

In some embodiments, the connector 200, 300 may include one or more drainage apertures 118. As previously described with respect to FIGS. 1A-1D, one or more drainage apertures 118 may be configured to facilitate the removal of fluid from within or around the connector. The drainage apertures 118 of connector 200, 300 are intended to encompass all of the various embodiments, features, and functionalities of the drainage apertures 118 previously described. The drainage apertures 118 of the connector 200, 300 may be located in positions which may be different from, or in addition to, the locations illustrated and described with respect to previously described drainage apertures 118.

In some embodiments, the connector 200, 300 may include one or more securing apertures 116. The securing apertures 116 of connector 200, 300 may include all of the various embodiments, features, and functionalities previously described. As shown in FIGS. 2A-2D and 3A-3D, the securing apertures 116 may be positioned inwardly or offset from one or more of the apertures 104, 108, and in some embodiments may align generally along a centerline that divides the cross sectional profiles of the apertures 104, 108, which may differ from, or be in addition to, the locations illustrated and described with respect to previously described securing apertures 116.

In some embodiments, the connector 200, 300 may include marker connectors 120 and markers 122. The marker connectors 120 and markers 122 of the connector 200, 300 may include all of the various embodiments, features, and functionalities previously described. As shown in FIGS. 2A-2D and 3A-3D, the marker connectors 120 and markers 122 may be positioned inwardly or offset from one or more of the apertures 104, 108, and in some embodiments may align generally along a centerline that divides the cross sectional profiles of the apertures 104, 108, which may differ from, or be in addition to, the locations illustrated and described with respect to previously described marker connectors 120 and markers 122.

In some embodiments, the connector 200, 300 may include one or more supports 124. The one or more supports 124 of the connector 200, 300 may include all of the various embodiments, features, and functionalities previously described. As shown in FIGS. 2A-2D and 3A-3D, the supports 124 may be arranged in a 3×2 matrix configuration. However, the number, spacing, and arrangement of the supports 124 may be greater or less in number, positioned closer or further apart from one another, arranged in different patterns or the like, which may differ from, or be in addition to, the locations illustrated and described with respect to previously described supports 124.

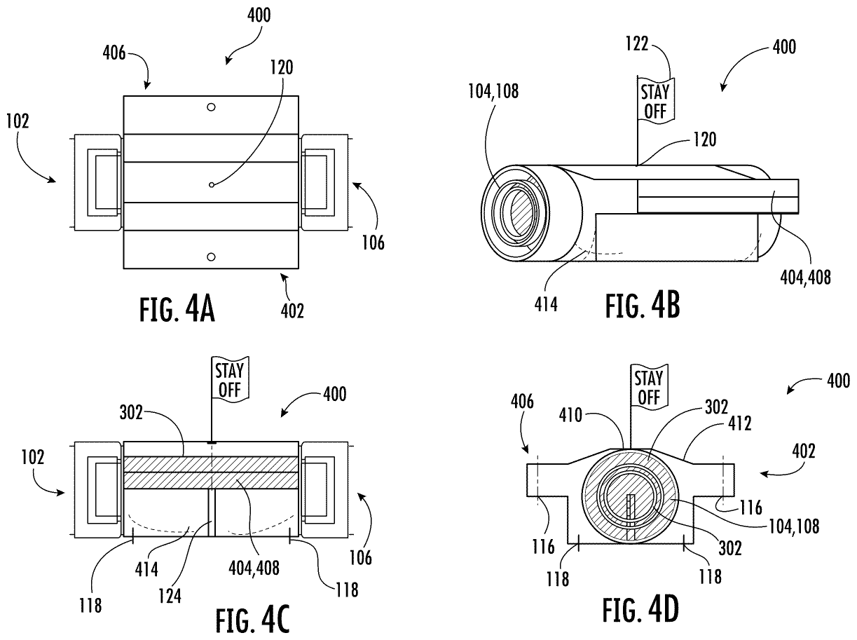

FIGS. 4A-4D illustrate an exemplary connector 400 (e.g., a rectangular vapor mitigation conduit to tubular conduit trunk line connector), in accordance with one or more embodiments of the present disclosure.

In some soil ventilation systems, rectangular vapor mitigation conduit branches often run perpendicular to a main conveyance “trunk line” of tubular conduit (e.g., conduit having a circular cross section, square cross section, polygonal cross section, or the like). To facilitate the flow of air (and vapors therein) into the tubular conduit for transportation and removal, a connector 400 may be provided, which can transition up to four rectangular vapor mitigation conduits to a tubular conduit and facilitate the airflow transition from the rectangular vapor mitigation conduits to tubular conduit.

The connector 400 may be defined by a cylindrical or other elongate body having a first portion 102 on one end of the body having a first aperture 104 for receiving a first vapor mitigation conduit (e.g., a first tubular conduit) and a second portion 106, disposed along a longitudinal axis of the body and on the opposite end of the body from the first portion 102, having a second aperture 108 for receiving a second vapor mitigation conduit (e.g., a second tubular conduit). The body may be substantially tubular such that a cavity is defined between the first aperture 104 and the second aperture 108 to allow for fluid communication therebetween.

Extending laterally outwards from a first side of the body may be a front portion 402 (e.g., a front wing) having a front aperture 404. Extending laterally outwards from a second side of the body may be a rear portion 406 (e.g., a rear wing) having a rear aperture 408. The front aperture 404 may be structured to receive a third vapor mitigation conduit (e.g., a first rectangular vapor mitigation conduit). Additionally, or alternatively, the rear aperture 408 may be structured to receive a fourth vapor mitigation conduit (e.g., a second rectangular vapor mitigation conduit). In such embodiments, the first and second apertures 104, 108 may be in fluid communication with the front aperture 404 and/or rear aperture 408, such that the front aperture 404 and/or rear aperture 408 extends inwardly to the cavity.

In some embodiments, the body may include one or more contours 414 (e.g., fillets, curves, chamfers, or the like) in the cavity to improve aerodynamics within the cavity and reduce turbulence, drag, or the like, when air moves through the cavity.

In some embodiments, the body may include a curved top surface 410 defining a removable cover 412. Stated differently, the front and rear apertures 404, 408 may be joined laterally below the curved top surface 410 such as to create a structural arch that adds strength to the connector 400. The removable cover 412 may be removed such as to provide visual or actual access to the cavity within the connector 400. In doing so, troubleshooting, assembly, inspection, or the like may be facilitated without requiring the complete removal of one or more of the vapor mitigation conduits. The removable cover 412 may be coupled via one or more fasteners, clips, hinges, or the like, to allow for removal and re-attachment.

In some embodiments, the first aperture 104, second aperture 108, the front aperture 404, and/or the rear aperture 408 may include a socket (e.g., coupling, adapter, or the like) for receiving the corresponding first, second, third, and/or fourth vapor mitigation conduit. For the first and second apertures 104, 108, the socket may have a generally rectangular cross-sectional shape or other suitable profile for engagement. In some embodiments, the socket may include one or more raised projections within the aperture positioned to engage (e.g., squeeze, lock, prevent further insertion, or the like) the first and/or second vapor mitigation conduit. For the front and rear apertures 404, 408, the socket may have a generally circular cross-sectional shape or other suitable profile for engagement, and may include one or more raised projections within the aperture positioned to engage the third and/or fourth vapor mitigation conduit.

In some embodiments, the front aperture 404 may be sized sufficient to receive not only the first rectangular vapor mitigation conduit, but also an additional rectangular vapor mitigation conduit in a stacked configuration with the first rectangular vapor mitigation conduit. Additionally, or alternatively, the rear aperture 408 may be dimensioned (e.g., sized and shaped) sufficient to receive not only the second rectangular vapor mitigation conduit, but also an additional rectangular vapor mitigation conduit in a stacked configuration with the second rectangular vapor mitigation conduit. In doing so, a connector 400 can support higher air flow in a compact size configuration that reduces the footprint required to do so.

In some embodiments, to allow for the selective use of the connector 400 (e.g., an on-site determination and adjustment as to how many vapor mitigation conduits will be operatively coupled to the connector 400), the front aperture 404 and/or the rear aperture 408 may include a knockout 302 that covers a portion of the front aperture 404 and/or the rear aperture 408, and sized to accommodate the one or more additional vapor mitigation conduits in a stacked relation with the third and/or fourth vapor mitigation conduits when removed, such as to selectively size the aperture(s). Some embodiments of the knockout 302 may include partial cuts and/or score lines to define a weakened perimeter, one or more tabs/bridge connections to hold the knockout in place until broken, or the like, such that the knockout 302 may be manually removed or removed via cutting tools.

Additionally, or alternatively, in some embodiments the first aperture 104 and/or the second aperture 108 may include one or more knockouts 302 that cover a portion of the first aperture 104 and/or the second aperture 108, and sized to accommodate various diameters (e.g., 1″, 2″, 3″, 4″, 5″, 6″, 7″, 8″, 9″, 10″, 12″ or the like diameter pipe), sizes, shapes, or the like, of the first and second vapor mitigation conduit (e.g., the first and second tubular conduit). For example, in some embodiments, the one or more knockouts 302 may be one or more concentric or centroid-centered knockouts that share a common center point with progressively larger rings scored or bridged around it, where an innermost knockout can be removed to create a smaller first and/or second aperture 104, 108, while outer rings may remain intact until a larger first and/or second aperture 104, 108 is required. Some embodiments of the knockout 302 may include partial cuts and/or score lines to define a weakened perimeter, one or more tabs/bridge connections to hold the knockout in place until broken, or the like, such that the knockout 302 may be manually removed or removed via cutting tools.

Additionally, or alternatively, in some embodiments, the first aperture 104 and/or the second aperture 108 may be fabricated with a predetermined diameter (e.g., 2″, 3″, 4″, 6″, 12″, or the like) depending upon the installation and tubular conduit specifications. In some embodiments, the first aperture 104 and/or the second aperture 108 may be fabricated with a predetermined diameter in conjunction with the previously described one or more knockouts 302.

In some embodiments, leaving some knockouts 302 undisturbed (e.g., remaining in place) while removing other knockouts 302 may allow for various configuration of flow paths within the connector 400. For example, in some embodiments, when one aperture for rectangular vapor mitigation conduit is closed (e.g., the front or rear apertures) and one aperture for the tubular conduit is closed (e.g., the first or second apertures), the connector 400 may function as a 90 degree routing adapter. In some embodiments, when both apertures for rectangular vapor mitigation conduit are closed (e.g., the front and rear apertures) and both apertures for the tubular conduit are closed (e.g., the first and second apertures), the connector 400 can function as a “tee” fitting. In some embodiments, when both apertures for rectangular vapor mitigation conduit are open (e.g., the front and rear apertures) and both apertures for the tubular conduit are open (e.g., the first and second apertures), the connector 400 functions as a “cross” fitting.

As a result of the selective use of the foregoing knockouts 302, the connector 400 may be used in many combinations of tubular conduit and rectangular vapor mitigation conduit (e.g., one to four rectangular vapor mitigation conduit sections to 3″ tubular conduit; one to four rectangular vapor mitigation conduit sections to 4″ tubular conduit; one to four rectangular vapor mitigation conduit sections to 6″ tubular conduit; 3″ tubular conduit to one to four rectangular vapor mitigation conduit sections to 3″ tubular conduit; 3″ tubular conduit to one to four rectangular vapor mitigation conduit sections to 4″ tubular conduit; 3″ tubular conduit to one to four rectangular vapor mitigation conduit sections to 6″ tubular conduit; 4″ tubular conduit to one to four rectangular vapor mitigation conduit sections to 4″ tubular conduit; 4″ tubular conduit to one to four rectangular vapor mitigation conduit sections to 6″ tubular conduit; 6″ tubular conduit to one to four rectangular vapor mitigation conduit sections to 6″tubular conduit, or the like).

In some embodiments, the connector 400 may include one or more drainage apertures 118. As previously described with respect to FIG. 1A-1D, one or more drainage apertures 118 may be configured to facilitate the removal of fluid from within or around the connector. The drainage apertures 118 of connector 400 are intended to encompass all of the various embodiments, features, and functionalities of the drainage apertures 118 previously described. The drainage apertures 118 of the connector 400 may be located in positions which may be different from, or in addition to, the locations illustrated and described with respect to previously described drainage apertures 118.

In some embodiments, the connector 400 may include one or more securing apertures 116. The securing apertures 116 of connector 400 may include all of the various embodiments, features, and functionalities previously described. As shown in FIGS. 4A-4D, the securing apertures 116 may be positioned at the front portion 402 and/or rear portion 406, which may differ from, or be in addition to, the locations illustrated and described with respect to previously described securing apertures 116.

In some embodiments, the connector 400 may include marker connectors 120 and markers 122. The marker connectors 120 and markers 122 of the connector 400 may include all of the various embodiments, features, and functionalities previously described. As shown in FIGS. 4A-4D, the marker connectors 120 and markers 122 may be at a midpoint along a longitudinal axis between the first portion 102 and the second portion 106, which may differ from, or be in addition to, the locations illustrated and described with respect to previously described marker connectors 120 and markers 122.

In some embodiments, the connector 400 may include one or more supports 124. The one or more supports 124 of the connector 400 may include all of the various embodiments, features, and functionalities previously described. As shown in FIGS. 4A-4D, a support 124 may be at a midpoint along a longitudinal axis between the first portion 102 and the second portion 106 and extend from the marker connector 120 through the cavity. However, the number, spacing, and arrangement of the supports 124 may be greater or less in number, positioned differently, arranged in a different pattern or the like, which may differ from, or be in addition to, the locations illustrated and described with respect to previously described supports 124.

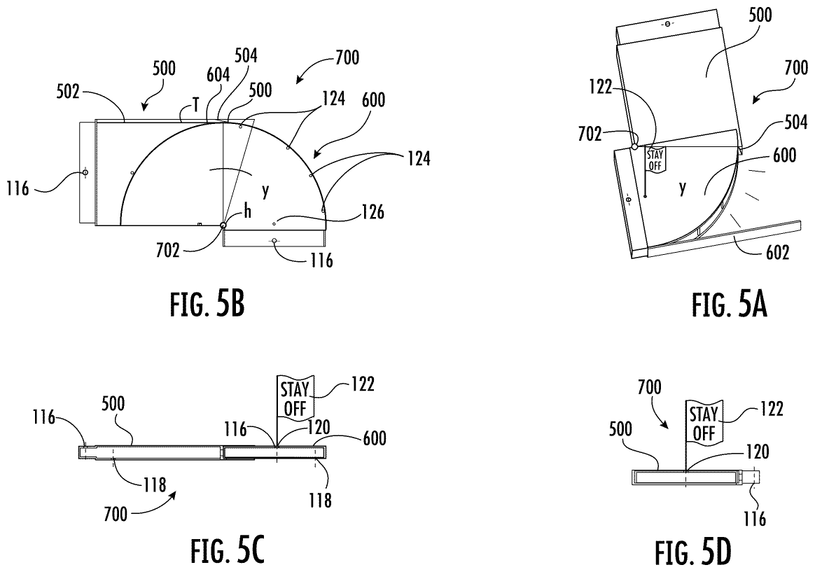

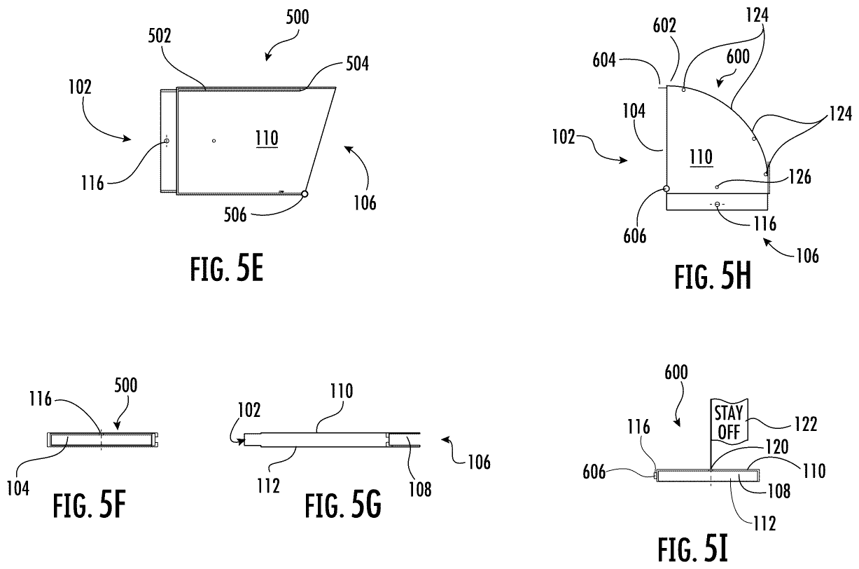

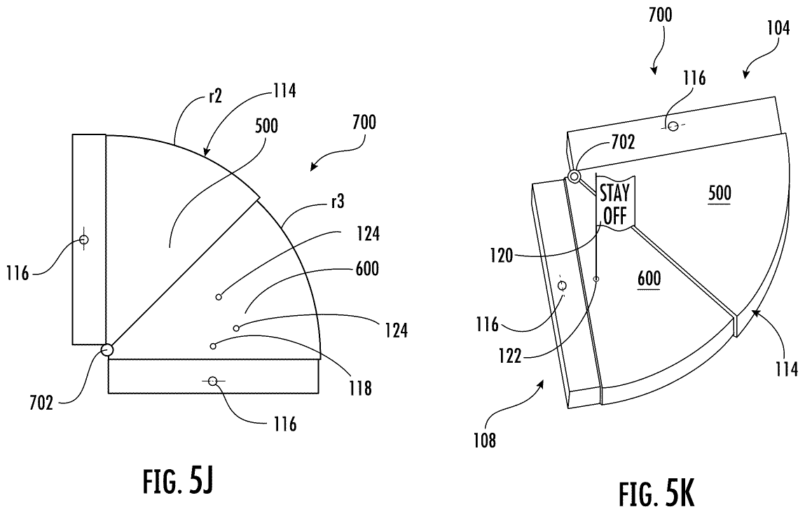

FIGS. 5A-5D illustrate a perspective view of an exemplary connector 700 (e.g., an adjustable angle rectangular vapor mitigation conduit connector), in accordance with one or more embodiments of the present disclosure. FIGS. 5E-5G illustrate a first subconnector 500 of the connector 700. FIGS. 5H-5I illustrate a second subconnector 600 of the connector 700.

In some vapor mitigation implementations, there is a need to change the direction of the rectangular vapor mitigation conduit and corresponding airstream therethrough. While fixed-angle connectors (e.g., connector 100, or the like) provide one solution, the connector 700 described herein allows for in-situ adjustment of the orientation of the apertures of the connector 700 to accommodate unconventional angles. Furthermore, a Stock Keeping Unit (SKU) count may be reduced by allowing for the use of multiple connectors 700 at a job site as opposed to an assortment of fixed-angle connectors.

As shown in FIGS. 5A-5D, the connector 700 may be an assembly of two or more subconnectors (e.g., a “first” subconnector 500, a “second” subconnector 600, or the like), where the subconnectors pivot about a hinge 702 relative each other to allow for adjustment to the desired angle between apertures, for example of 90, 100, 110, 120, 130, 140, 150, 160, 170, 180 degrees, or the like.

With reference to FIGS. 5E-5G, a first subconnector 500 may be defined by a body having a first portion 102 for receiving a first vapor mitigation conduit (e.g., a first rectangular vapor mitigation conduit) and a second portion 106 with an open aperture (e.g., not necessarily for receiving a second rectangular vapor mitigation conduit). A top wall 110 may extend from an upper surface of the first portion 102 to an upper surface of the second portion 106, while a bottom wall 112 may be in a spaced relation from the top wall 110 and may extend from a lower surface of the first portion 102 to a lower surface of the second portion 106. To receive the first vapor mitigation conduit, the first portion 102 may include a first aperture 104 proximate the first portion 102. The second aperture 108 may be any suitable aperture that allows for flow of air from the first vapor mitigation conduit within a cavity of the subconnector 500 to other portions of the overall connector 700 (e.g., to a cavity of the subconnector 600, or the like).

Indeed, to facilitate the fluid communication (e.g., the allowing of air flow) between the first aperture 104 and the second aperture 108, the body of the subconnector 500 may be a hollow member defining a cavity (e.g., an air channel) therein for operatively coupling the first aperture 104 to the second aperture 108, where in some embodiments the cavity may be at least partially defined by the top wall 110 and the bottom wall 112.

In some embodiments, the body may be structured as a unibody structure. In other embodiments, the body may be structured as two or more mating portions configured to interlock with one another. The mating portions may join along a split line extending substantially, horizontally, vertically, or in any other plane suitable for assembly or disassembly.

In some embodiments, the first aperture 104 and/or the second aperture 108 may be defined by a rectangular cross-section having opposing long edges and opposing short edges, where the short edges extend generally vertical when the connector is oriented horizontally. Additionally, or alternatively, the first aperture 104 and/or the second aperture 108 may be defined by a non-rectangular cross-section, and may be circular, oval, polygonal, irregular in shape, or the like. In some embodiments, the first aperture 104 and/or the second aperture 108 may include curved, angled, contoured wall portions, keying features, notches, or tapered surfaces that guide insertion or improve sealing engagement.

As illustrated, the first portion 102 and the second portion 106 of the subconnector 500 may be arranged such that a longitudinal axis of the first vapor mitigation conduit is aligned with a longitudinal axis of the body of the subconnector 500 with one another (e.g., disposed on opposing sides of a longitudinal axis of the body).

In some embodiments, the first aperture 104 may include a socket (e.g., coupling, adapter, or the like) for receiving the corresponding first vapor mitigation conduit. The socket may have a generally rectangular cross-sectional shape or other suitable profile for engagement. In some embodiments, the socket may include one or more raised projections within the aperture positioned to engage (e.g., squeeze, lock, prevent further insertion, or the like) the first and/or second vapor mitigation conduit.

As previously described, the subconnector 500 and subconnector 600 may be operatively coupled to each other at a hinge 702 to result in the connector 700. Accordingly, the subconnector 500 may include a first hinge portion 506. The first hinge portion 506 may include one or more hinge features for rotatably coupling the subconnector 500 with a corresponding hinge portion (e.g., second hinge portion 606) on an adjacent subconnector (e.g., subconnector 600). In some embodiments, the first hinge portion 506 may define an engagement structure such as a loop, ear-like tab, tab-and-clip, knuckle, barrel, socket region, folding accordion type hinge, arched hinge with a groove and track, or the like that aligns with and interfits with complementary features of the second hinge portion 606. Additionally, or alternatively, the first hinge portion 506 may include one or more apertures, recesses, bearing surfaces, or the like suitable for receiving a hinge pin, rod, or other connecting element that facilitates relative rotation between the first hinge portion 506 and the second hinge portion 606. In some embodiments, the first hinge portion 506 may be formed integrally with the subconnector 500, while in other embodiments it may be a discrete element secured by fastening, bonding, or the like.

The second aperture 108 may be sized sufficiently to receive at least a portion of the subconnector 600 therein (e.g., the top wall 110, bottom wall 110, and/or the flexible member 602) to allow for various angular positions. The second aperture 108 may be sized to minimize air gaps between the subconnector 500 and subconnector 600 when the subconnector 500 receives the subconnector 600 therein.

In some embodiments, the subconnector 500 may include a track 502 along a wall (e.g., an inner wall of the cavity proximate the second aperture 108, an outer wall of the body, or the like). In some embodiments, the track 502 may be defined by a two-piece retainer with equal sections that are approximately 1/4 inch from the top wall 110 and bottom wall 112. Additionally, or alternatively, the track 502 may include inwardly extending fingers that receive at a receiver 504 a corresponding element of an adjacent subconnector, for example the flexible member 602 of the subcomponent 600, as will be described herein. Additionally, or alternatively, in some embodiments, there may be a stop at the end of the track such that when the corresponding element to be received in the track 502 is prevented from being fully extended or removed therefrom.

With reference now to FIGS. 5H-5I, a subconnector 600 may be defined by a body having a second portion 106 for receiving a second vapor mitigation conduit (e.g., a second rectangular vapor mitigation conduit) and a first portion 102 with an open aperture (e.g., not necessarily for receiving a rectangular vapor mitigation conduit). A top wall 110 may extend from an upper surface of the first portion 102 to an upper surface of the second portion 106, while a bottom wall 112 may be in a spaced relation from the top wall 110 and may extend from a lower surface of the first portion 102 to a lower surface of the second portion 106. To receive the second vapor mitigation conduit, the second portion 106 may include a second aperture 108 proximate the second portion 106. A first aperture 104 may be provided at the first portion 102 and may be any suitable aperture that allows for flow of air from the second vapor mitigation conduit within a cavity of the subconnector 600 to other portions of the overall connector 700 (e.g., to a cavity of the subconnector 500, or the like).

Indeed, to facilitate the fluid communication (e.g., the allowing of air flow) between the first aperture 104 and the second aperture 108, the body of the subconnector 600 may be a hollow member defining a cavity (e.g., an air channel) therein for operatively coupling the first aperture 104 to the second aperture 108, where in some embodiments the cavity may be at least partially defined by the top wall 110 and the bottom wall 112.

In some embodiments, the body may be structured as a unibody structure. In other embodiments, the body may be structured as two or more mating portions configured to interlock with one another. The mating portions may join along a split line extending substantially, horizontally, vertically, or in any other plane suitable for assembly or disassembly.

In some embodiments, the first aperture 104 and/or the second aperture 108 may be defined by a rectangular cross-section having opposing long edges and opposing short edges, where the short edges extend generally vertical when the connector is oriented horizontally. Additionally, or alternatively, the first aperture 104 and/or the second aperture 108 may be defined by a non-rectangular cross-section, and may be circular, oval, polygonal, irregular in shape, or the like. In some embodiments, the first aperture 104 and/or the second aperture 108 may include curved, angled, contoured wall portions, keying features, notches, or tapered surfaces that guide insertion or improve sealing engagement.

As illustrated, the first portion 102 and the second portion 106 of the connector 600 may be arranged such that the second mitigation conduit is oriented substantially orthogonally to the first aperture 104. Stated differently, a theoretical longitudinal axis extending from the first aperture 104 may be positioned approximately 90 degrees from a theoretical longitudinal axis extending from the second aperture 108. While the illustrated embodiment depicts the first and second portions 102, 106 arranged at an angle of approximately 90°, other angular relationships are contemplated, including angles of about 30°, 45°, 60°, 75°, 105°, 120°, 135°, or 150°, as well as any intermediate values.

In some embodiments, the second aperture 108 may include a socket (e.g., coupling, adapter, or the like) for receiving the corresponding first vapor mitigation conduit. The socket may have a generally rectangular cross-sectional shape or other suitable profile for engagement. In some embodiments, the socket may include one or more raised projections within the aperture positioned to engage (e.g., squeeze, lock, prevent further insertion, or the like) the first and/or second vapor mitigation conduit.

As previously described, the subconnector 500 and subconnector 600 (as will be described henceforth) may be operatively coupled to each other at a hinge 702 to result in the connector 700. Accordingly, the subconnector 600 may include a second hinge portion 606. The second hinge portion 606 may include one or more hinge features for rotatably coupling the subconnector 600 with a corresponding hinge portion (e.g., first hinge portion 506) on an adjacent subconnector (e.g., subconnector 500). In some embodiments, the second hinge portion 606 may define an engagement structure such as a loop, ear-like tab, tab-and-clip, knuckle, barrel, socket region, folding accordion type hinge, arched hinge with a groove and track, or the like that aligns with and interfits with complementary features of the first hinge portion 506. Additionally, or alternatively, the second hinge portion 606 may include one or more apertures, recesses, bearing surfaces, or the like suitable for receiving a hinge pin, rod, or other connecting element that facilitates relative rotation between the first hinge portion 506 and the second hinge portion 606. In some embodiments, the second hinge portion 606 may be formed integrally with the subconnector 600, while in other embodiments it may be a discrete element secured by fastening, bonding, or the like.

Extending from an outer short edge of the first aperture 104 to an outer short edge of the second aperture 108 may be an outer wall 114. In some embodiments, the outer wall 114 may extend along a defined radius r1 to result in a ninety-degree arc (e.g., a quarter circle), though various arc lengths and angles are contemplated, including between 10 and 90 degrees, between 90 and 180 degrees, between 180 and 240 degrees, between 240 and 360 degrees, or the like. In some embodiments, the outer wall 114 may be a flexible member 602 or the outer wall 114 may include a flexible member 602 thereon. Supports 124, as will be described, may be guarded by the flexible member 602. The flexible member 602 may be an elongate, strip-like flexible or resilient member. The flexible member 602 is illustrated in FIG. 5A in a position not yet received by the track 502. However, the track 502 of the subconnector 500 may slidably receive a leading edge 604 of the flexible member 602 (e.g., in a grooved portion of the track 502) and continue to receive the flexible member 602 as it advances when the subconnector 500 rotates relative to connector 600, or vice-versa. In some embodiments, the flexible member 602 may include a wedge-shaped stop (e.g., at the leading edge 604) that slides in the corresponding portions of the track 502.

In some embodiments, the cavity may also be defined by the flexible member 602 or the outer wall 114. This curved cavity configuration may facilitate airflow with reduced flow restriction and inducing only minimal turbulence and drag through the connector 100. Additionally, or alternatively, the cavity may include one or more contoured surfaces (e.g., surface transitions) such as chamfers, fillets, radii, or the like, for further reducing flow restriction.

Returning now to FIGS. 5A-5D, the subconnector 500 and the subconnector 600 may be assembled such that the first portion may be rotatably coupled to the second portion, such as to allow for selective positioning relative to each other (e.g., between about 0 and about 90 degrees, between about 45 and about 90 degrees, between about 90 and about 180 degrees, between about 135 and about 180 degrees, or the like). To do so, the first hinge portion 506 may be hingedly connected to the second hinge portion 606 to result in the hinge 702. In some embodiments, a hinge pin or the like may be inserted through the hinge 702 to secure the subconnectors 500, 600 to each other. Additionally, or alternatively, a substrate anchor such as a stake, spike, or other securing member may be inserted through the pivot axis of the hinge 702 to provide for an anchoring point of the connector 700.

As is the case with any of the foregoing embodiments of connectors, in some embodiments, once the first and second vapor mitigation conduits have been operatively coupled to the connector 700, the joints between the first and second vapor mitigation conduits and the connector 700 may be wrapped with tape (e.g., duct tape, or the like), construction adhesive, vaport barrier tape, or the like.

In some embodiments, the connector 700 (e.g., subconnector 500 and/or subconnector 600) may include one or more drainage apertures 118. The drainage apertures 118 of connector 700 are intended to encompass all of the various embodiments, features, and functionalities of the drainage apertures 118 previously described. As shown in FIGS. 5A-5I, the drainage apertures 118 of the connector 700 may be positioned proximate the first portion 102 of the subconnector 500 and the second portion 106 of the subconnector 600, or located in positions which may be different from, or in addition to, the locations illustrated and described with respect to previously described drainage apertures 118.

In some embodiments, the connector 700 (e.g., subconnector 500 and/or subconnector 600) may include one or more securing apertures 116. The securing apertures 116 of connector 700 may include all of the various embodiments, features, and functionalities previously described. As shown in FIGS. 5A-5I, the securing apertures 116 may be positioned at the hinge 702 and/or proximate the second aperture 108 of the subconnector 600, which may differ from, or be in addition to, the locations illustrated and described with respect to previously described securing apertures 116.

In some embodiments, the connector 700 (e.g., subconnector 500 and/or subconnector 600) may include marker connectors 120 and markers 122. The marker connectors 120 and markers 122 of the connector 700 may include all of the various embodiments, features, and functionalities previously described. As shown in FIGS. 5A-5I, the marker connectors 120 and markers 122 may be positioned proximate the first portion 102 of the subconnector 500 and the second portion 106 of the subconnector 600, which may differ from, or be in addition to, the locations illustrated and described with respect to previously described marker connectors 120 and markers 122.

In some embodiments, the connector 700 (e.g., subconnector 500 and/or subconnector 600) may include one or more supports 124. The one or more supports 124 of the connector 700 may include all of the various embodiments, features, and functionalities previously described. As shown in FIGS. 5A-5I, supports 124 may arranged along the curve defined by the outer wall 114 and/or the flexible member 602. However, the number, spacing, and arrangement of the supports 124 may be greater or less in number, positioned differently, arranged in a different pattern or the like, which may differ from, or be in addition to, the locations illustrated and described with respect to previously described supports 124.

Turning now to FIG. 5J-5K, it shall be appreciated that certain embodiments of connector 700 may take on alternate configurations of subconnectors 500 and 600. While the embodiments of FIGS. 5A-5I illustrate subconnector 500 as having a generally rectangular profile with first and second apertures 104 and 108 aligned along a longitudinal axis, and subconnector 600 as having apertures 104 and 108 oriented substantially orthogonal to each other, FIGS. 5J-5K depict one possible alternative embodiment. In this embodiment, subconnector 500 may be formed as a wedge-shaped segment corresponding to a portion of a circle, the outer wall 114 following a radius r₂. The first and second apertures 104 and 108 may be oriented at an acute angle relative to one another. Subconnector 600 may similarly be shaped as a complementary wedge segment having an outer wall 114 defined by a radius r3, where r3 is slightly smaller than r2, allowing the two subconnectors to interface closely.

The structural and functional aspects previously described with respect to FIGS. 5A-5I may still apply. For example, the second aperture 108 of subconnector 500 may receive the first aperture 104 of subconnector 600, and the two may be pivotably or operatively coupled to one another by way of a hinge 702. In some embodiments, a separate hinge pin, rod, or other connecting feature may extend through one or both apertures to define the rotational axis, while in other implementations the coupling may be achieved integrally through molded or machined engagement features. In some embodiments, the subconnector 500 may include a track 502 for receiving a flexible member 602 of subconnector 600, however in other embodiments the flexible member 602 and/or corresponding track 502 may be omitted.

Unless otherwise defined, all terms (including technical and scientific terms) used herein have the same meaning as commonly understood by one of ordinary skill in the art to which this disclosure belongs. It will be further understood that the terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the disclosure. For example, words such as “upper,” “lower,” “left,” “right,” “horizontal,” “vertical,” “upward,” and “downward” merely describe the configuration shown in the figures. The referenced components may be oriented in an orientation differently that shown in the drawings and the terminology, therefore, should be understood as encompassing such variations unless specified otherwise.

It will be understood that when an element is referred to as being “connected,” “coupled,” or “operatively coupled” to another element, the elements can be formed integrally with each other, or may be formed separately and put together. Furthermore, “connected,” “coupled,” or “operatively coupled” to can mean the element is directly connected, coupled, or operatively coupled to the other element, or intervening elements may be present between the elements. Furthermore, “connected,” “coupled,” or operatively coupled” may mean that the elements are detachable from each other, or that they are permanently coupled together.

Many modifications and other embodiments of the present disclosure will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

1. A connector for vapor mitigation conduit, the connector comprising:
a body comprising:
a first portion and a second portion;
a first aperture proximate the first portion for operatively coupling with a first vapor mitigation conduit; and
a second aperture proximate the second portion for operatively coupling with a second vapor mitigation conduit, wherein the second aperture is in fluid communication with the first aperture.

2. The connector of claim 1, wherein the first vapor mitigation conduit or the second vapor mitigation conduit comprises a vapor mat.

3. The connector of claim 1, wherein the first vapor mitigation conduit or the second vapor mitigation conduit comprises a tubular body.

4. The connector of claim 1, wherein the body comprises a cavity for operatively coupling the first aperture to the second aperture, and wherein the connector further comprises at least one drainage aperture in fluid communication with the cavity for draining condensate to outside the connector.

5. The connector of claim 4, further comprising one or more supports extending through a top wall and a bottom wall of the cavity.

6. The connector of claim 1, wherein the first portion and the second portion are disposed on opposing sides of a longitudinal axis of the body.

7. The connector of claim 6, further comprising one or more sleeves parallel to the longitudinal axis on opposing sides of the connector for receiving reinforcement rods or electrical conduit.

8. The connector of claim 6, further comprising:
a receptacle proximate the first portion or the second portion, the receptacle structured to receive an adjacent connector therein.

9. The connector of claim 1, wherein the first portion and the second portion are arranged such that the first vapor mitigation conduit and the second mitigation conduit are oriented substantially orthogonally to one another.

10. The connector of claim 9, wherein the body comprises a cavity for operatively coupling the first aperture to the second aperture, and wherein the cavity is at least partially defined by an arc having a radius extending from the first aperture to the second aperture.

11. The connector of claim 1, wherein the first portion is rotatably coupled to the second portion, such that the first vapor mitigation conduit and the second mitigation conduit are selectively positionable relative to one another.

12. The connector of claim 11, wherein the first portion or the second portion comprises a flexible member, wherein the other of the first portion and the second portion comprises a track structured to slidably receive the flexible member as the first portion rotates relative to the second portion.

13. The connector of claim 11, wherein the first portion and the second portion are rotatable between 10 and 110 degrees relative to each other.

14. The connector of claim 1, wherein the body further comprises at least one securing aperture for receiving a substrate anchor operative to secure at least a portion of the body substantially stationary relative to a substrate.

15. The connector of claim 14, wherein the substrate anchor is further operative to secure the first vapor mitigation conduit or the second vapor mitigation conduit substantially stationary relative to the body.

16. The connector of claim 1, wherein at least one of the first aperture and the second aperture are defined by at least one knockout removable for selective sizing.

17. The connector of claim 16, wherein removing the at least one knockout allows for a third vapor mitigation conduit to be received therein, the third vapor mitigation conduit in a stacked configuration with the first vapor mitigation conduit or the second vapor mitigation conduit.

18. The connector of claim 1, further comprising:
a marker connector for receiving a marker therein.

19. The connector of claim 18, wherein the marker comprises a flag, and wherein the maker connector comprises a coupling for securing the marker.

20. A system for mitigation of vapors in a substrate, the system comprising:
a first vapor mitigation conduit proximate a substrate;
a second vapor mitigation conduit;
a connector, the connector comprising:
a body comprising a first portion and a second portion;
a first aperture proximate the first portion for operatively coupling with the first vapor mitigation conduit; and
a second aperture proximate the second portion for operatively coupling with the second vapor mitigation conduit, wherein the second aperture is in fluid communication with the first aperture;
a flow generator operatively coupled to the second vapor mitigation conduit to move the vapors from the first vapor mitigation conduit to the second vapor mitigation conduit via the connector.
